(19) United States
(12) Patent Application Publication
(10) Pub. No.: US 2013/0080435 A1
(43) Pub. Date: Mar. 28, 2013

(54) METHOD AND APPARATUS FOR MANAGING ONLINE CONTENT COLLECTIONS

(71) Applicants: Eric James Gieseke, Lincoln, MA (US); Anindita Mahapatra, Methen, MA (US)

(72) Inventors: Eric James Gieseke, Lincoln, MA (US); Anindita Mahapatra, Methen, MA (US)

(73) Assignee: Nokia Corporation, Espoo (FI)

(21) Appl. No.: 13/242,807

(22) Filed: Sep. 23, 2011

(51) Int. Cl. G06F 17/30

(52) U.S. Cl. 707/737; 707/E17.009

(57) ABSTRACT

An approach is presented for managing content collections at various hierarchical layers. A content management platform causes a specification of one or more hierarchical layers for managing content associated with one or more content stores. The content management platform then determines at least one content collection associated with the one or more content stores. It then determines to organize the at least one content collection into one or more bins associated with respective ones of the one or more hierarchical layers.

### BACKGROUND

Network service providers and device manufacturers are continually challenged to deliver value and convenience to consumers by, for example, providing compelling network services. One of the network features that are recently gaining increasing attention is providing online services or content (e.g. applications, games, media, etc.) via an online store or repository. In order to increase the number of hits for suggested services or content, online service providers often need to suggest relevant services. One traditional way to provide suggestions is through content collections (e.g., a list or grouping of content organized by themes, topics, etc.) to present content items of potential interest to user. However, content collections are usually dependent on factors such as user interests (past experience), demographic, type and capabilities of user equipment, location, etc. (also referred to as milieu information). Accordingly, service providers and device manufacturers face significant technical challenges to enabling online store managers to more efficiently manage content collections in light of the milieu factors listed above.

### Some Example Embodiments

Therefore, there is a need for an approach to managing content collections at various layers of a hierarchy based, e.g., on the milieu factors considered by online stores (e.g., content/application stores).

According to one embodiment, a method comprises causing, at least in part, a specification of one or more hierarchical layers for managing content associated with one or more content stores. The method also comprises determining at least one content collection associated with the one or more content stores. The method further comprises determining to organize the at least one content collection into one or more bins associated with respective ones of the one or more hierarchical layers.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a specification of one or more hierarchical layers for managing content associated with one or more content stores. The apparatus is also caused to determine at least one content collection associated with the one or more content stores. The apparatus is further caused to determine to organize the at least one content collection into one or more bins associated with respective ones of the one or more hierarchical layers.

According to another embodiment, a computer-readable storage medium carries one or more sequences of one or more instructions which, when executed by one or more processors, cause, at least in part, an apparatus to cause, at least in part, a specification of one or more hierarchical layers for managing content associated with one or more content stores. The apparatus is also caused to determine at least one content collection associated with the one or more content stores. The apparatus is further caused to determine to organize the at least one content collection into one or more bins associated with respective ones of the one or more hierarchical layers.

According to another embodiment, an apparatus comprises means for causing, at least in part, a specification of one or more hierarchical layers for managing content associated with one or more content stores. The apparatus also comprises means for determining at least one content collection associated with the one or more content stores. The apparatus further comprises means for determining to organize the at least one content collection into one or more bins associated with respective ones of the one or more hierarchical layers.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-9, 20-29, and 44-46.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of managing content collections at various hierarchical layers, according to one embodiment;

FIG. 2A is a diagram of the components of a content management platform, according to one embodiment;

FIG. 2B is a diagram of a collection object model employed by the content management platform, according to one embodiment;

FIG. 3A is a diagram depicting reconciliation content to be displayed across multiple bins of a content collection, according to one embodiment;

FIG. 3B is a diagram of an override scenario for one or more bins at one or more hierarchical layers of a content collection, according to one embodiment;

FIGS. 4A-4E are flowcharts of processes for managing content collections at various hierarchical layers, according to various embodiments;

FIG. 5 is a diagrams of a user interface for configuring one or more content collections, according to one embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for managing content collections at various hierarchical layers are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

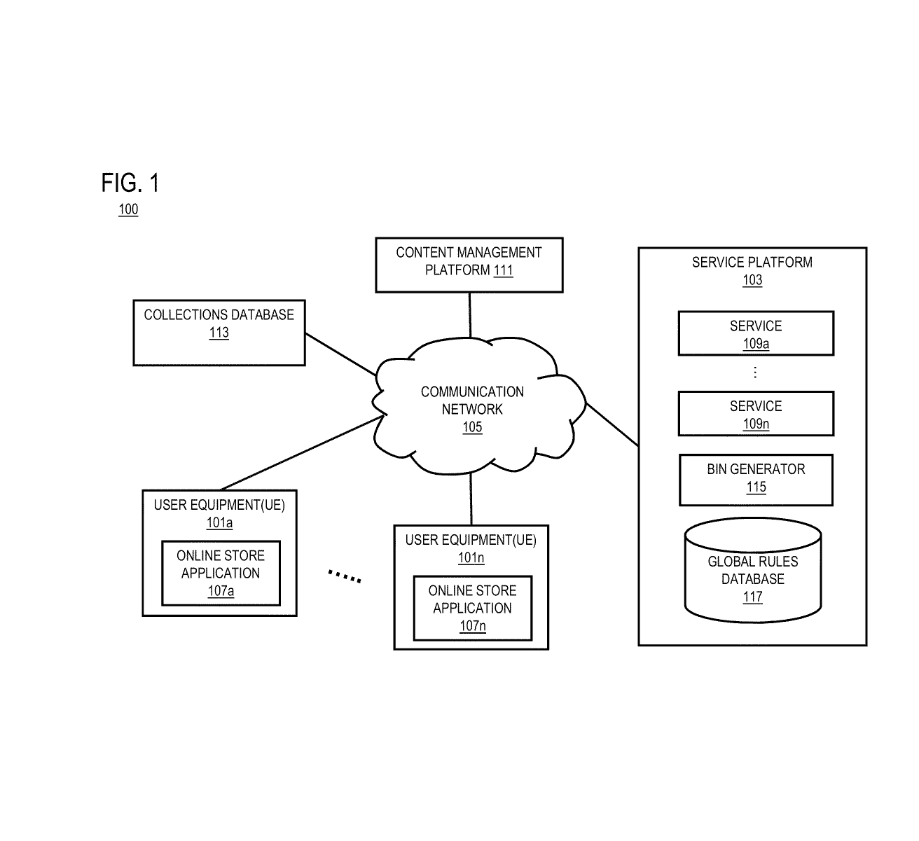

FIG. 1 is a diagram of a system capable of managing collections of content at various layers of a hierarchy, according to one embodiment. As noted previously, content store managers often have a need to be able to provide the most relevant combination of suggested services or content as, for instance, one or more content collections available for selection from an online content store (e.g., an application store). Generally, at least a few content collections (e.g., organized by themes, content type, etc.) appear on an equipment display unit when a potential customer enters or accesses the online store. However, service providers and device manufacturers face significant technical challenges to ensuring that such landing pages present content that is appropriate for a particular region as well as other milieu factors or characteristics such as device type, language, network operator, etc. This is particularly important as content stores become global enterprises encompassing hundreds of thousands of content items. For example, an application available as downloadable content may be popular in the United States, but not particularly compelling in the Middle East. Similarly, movie content presented in content collections presented to visitors in certain African countries may generate more sales when the available titles are those generally known or accepted by the populous.

Typically, managers at various levels of jurisdiction, including global, regional or country, are responsible for determining what content to present to users at the online store. Such decisions are made based on the relative needs, interests and customs of their respective customer base. Hence, a hierarchical structure that includes managers operating at different layers/levels of responsibility and market scope requires coordination. Historically, these hierarchical content managers have faced the burden of creating multiple content collections, even if they cover the same themes, etc., for each of the different regions, market scope, etc. As a result, the management of content collections for a global content store can become extremely burdensome as the number of jurisdictions, content collections, content items, etc. increase.

To address this problem, a system 100 of FIG. 1 introduces the capability to manage content collections at a top level of a defined hierarchy (e.g., in the case of a location-based hierarchy, the top level is the global level) with overrides available at lower levels of the hierarchy. In one embodiment, the system 100 enables a single content collection to be organized into multiple bins of content items spanning the various hierarchical layers. These bins, for instance, may provide for different mixes of content items, different sort orders, etc. at different hierarchical layers. For example, a content collection, according to various embodiments may, include a bin corresponding to one layer of geographic granularity (e.g., a global level) and another bin corresponding to another layer (e.g., regional level). Then, depending on the available milieu information (e.g., location, language, device, etc.) and its specificity, the system 100 can select the appropriate bin of the content collection to a user. In this way, a single content collection can include an internal hierarchical structure capable of responding (e.g., filtering appropriate content) to users from any location, demographic, etc. In certain embodiments, the system 100 includes a content management platform 111 that is configured to perform the various embodiments of hierarchy-based content collection management as described herein.

Content collections may include, for example, any grouping of content sharing one or more common attributes. Within the context of an online store, a collection may be defined to support a theme pack, advertising campaigns, home page of one or more companies, a recommendation list, etc. Attributes of a collection may therefore include those reflecting the interests of the users to which the content is directed, such as based on a common geographic location, demographic, or a combination thereof. By way of example, milieu information pertaining to the user, which includes information pertaining to the context of the user or a device of the user, may be matched with a corresponding collection. In one use case under this scenario, a collection of sports related content targeted may include multiple bins such as one bin for patrons living in a particular city that may feature content related to the local football, baseball, soccer and other sports teams of that locale, and another bin of content representing a group of national football, baseball, soccer, etc. teams for users associated with milieu information indicating a national preference.

Content may include, for example, any data capable of being accessed, retrieved, downloaded, or otherwise executed by a calling application such as a web browser, online store application, or the like. By way of example, content may include video data, audio data, image data, internet data, data files, executable object code (e.g., applications or games), web services, contextual and semantic data, textual data and the like. In certain embodiments, the content management platform 111 enables content to be added to one or more collections at various layers of hierarchy. By way of example, the hierarchical layers may correspond to a management structure of the service provider (online store host), a level of jurisdiction or responsibility of one or more operators of the service provider, a level of granularity of consumer interests, a level of access to the content management platform, etc. For the purpose of illustration, the exemplary techniques are described from the perspective of a hierarchy comprising a global, country and regional hierarchical structure.

By way of example, the global layer corresponds to a global layer of online content management as managed by a global manager; the country layer corresponds to a country level of online content management as managed by a country manager; and a regional layer corresponds to a regional level of online content management as managed by a regional manager. The manager at a respective layer creates, via the content management platform 111, a bin for specifying content to be included at his or her respective level of the content collection based on the corresponding layer. For example, a global bin may specify or contain content corresponding to the global layer, while at the regional layer, a regional bin maintains the content that will be presented to users at the regional layer. Each bin contains an ordered list of content comprising at least a portion of the collection. In one embodiment, content from different bins at different hierarchical layers may be combined using, for instance, one or more algorithms to reconcile duplicates, sort orders, etc. across the multiple bins to provide a coherent list to the user.

In other words, the interaction between the various layers, including their order of priority and specific override privileges, is defined according to one or more rules. Rules are specified or applied at a global level, country or regional (local) level (e.g., affecting filtering of content from the collection based, at least in part, on one or more criteria such as location, operator), or a combination thereof. In addition, the rules specify one or more filters, rules or executions for defining the means of content selection and programming. This capability, for instance, enables the service providers to direct content for specific product promotions (e.g., whitelists) or to prohibit content (e.g., blacklists) in the online store for specific hierarchical levels such as countries, regions, etc. It is noted that any number of hierarchical layers representing, for instance, varying levels of granularity of the hierarchical structure may also be implemented in certain embodiments, e.g., city layer, postal zip code layer, campus layer, community layer, etc.

In one embodiment, the rules comprise instructions or filters for enabling application content programming to be performed at respective layers of the hierarchy. The filters may be established to determine content programming to be stored (e.g. in the form of RDF graphs). The stored rules or filters may be accessed and used by the processing components of the content management platform 111. The service platform administrators may then preview the rule or filter behavior, by seeing how the landing pages of the online store may be presented, before approving the rules or filters to go live (public).

By way of example, one way of controlling the content items or bins of a content collection presented on a user equipment is via a set of filters that are defined for each of the available landing spots in the structure of the online store landing page. These filters control how content is selected to appear on the page based on criteria such as recent activity, price, category, etc. It is noted that content priorities may also differ for different devices, countries, regions, languages, etc. They may also differ according to user's specific needs. Moreover, the rules or filters can be edited periodically based on current promotions, user interest, and other user milieu information.

In one embodiment, filters may be generated and stored using Resource Description Framework (RDF) format. RDF is a family of World Wide Web Consortium (W3C) specifications originally designed as a metadata data model. It has come to be used as a general method for conceptual description or modeling of information that is implemented in web resources; using a variety of syntax formats. The underlying structure of any expression in RDF is a collection of triples, each consisting of three disjoint sets of nodes including a subject, a predicate and an object. A subject is an RDF URI reference (U) or a Blank Node (B), a predicate is an RDF URI reference (U), and an object is an RDF URI reference (U), a literal (L) or a Blank Node (B). A set of such triples is called an RDF graph.

TABLE 1

| Subject | Predicate | Object |
|---|---|---|
| uri://....../rule#CD-introduction, | rdf:type, | uri://............/Rule |
| uri://....../rule#CD-introduction, | uri://....../rule#assumption, | “c” |

Rules for defining override capabilities at respective hierarchical layers are also defined. Overrides may include a level of importance or priority of one layer versus another, a degree of content selection and management privileges of one level versus another, or a combination thereof, a level of data overwriting and/or deletion capability at one level versus another, or a combination thereof. By way of example, Table 2 presents the examples of behavior of the online store for supporting selection, presentation, or modification of collections at various hierarchical layers.

TABLE 2
BIN ALLOCATION/MANAGEMENT
At least one bin must be defined, but others are optional.
One global bin, but multiple regional and country level bins may exist
per collection_{—}
CONTENT SELECTION
Content selection starts with country bin, then regional bin and finally
global bin.
Duplicate content is filtered from a resulting bin
Sort order or content selections are preserved
OVERRIDES
Content selection starts with country bin, then regional bin and finally
global bin
Changes to the collection at the global layer (global bin) ripple through
and are visible to the regional and country bin
Changes at the regional layer (regional bin) are visible to the country
level (country bin)
Country level changes do not affect the parent region (e.g., a Pacific
Region may include multiple countries)
Regional level changes do not affect global bin configuration
Country has precedence over region, region has precedence over global

As shown in FIG. 1, the system 100 comprises a user equipment (UE) 101 having connectivity to a service platform 103 and a content management platform 111 via a communication network 105.

In one embodiment, the service platform 103 comprises information regarding available services 109a-109n for facilitating the online store. The information may include service requirements, restrictions, priorities, licensing information etc. Also, the service platform 103 includes a bin generator 115, which enables one or more managers to establish bins for use at various hierarchical layers. The bin generator 115 may also be configured to define the sorting of content as presented within a collection, including which content is presented first in a list, second, third, and so on. Rules for affecting bin configuration and interaction, e.g., per Table 2, are stored in the global rules database 117. As will be more fully discusses later, the bin generator 115 may be presented by the content management platform 111 to a display of a user device of a manager for enabling establishment and adaptation of bins. For example, an online store application 107 may feature a link for enabling accessing of the content management platform 111 by managers based on their respective level of access.

In certain embodiments, the global rules database 117 may be stored in the collections database 113 so that it can be accessed by the content management platform 111 directly without having to communicate with the service platform 103. As noted previously, the rules 117 may include one or more instructions for enabling the propagation of adaptations to collections or specific content associated therewith throughout various layers of a management/configuration hierarchy. Still further, the rules base may pertain to settings for facilitating global configuration with regional, country level and operator specific overrides.

In one embodiment, the content management platform 111 enables managers to configure the arrangement and presentment of content via one or more bins at landing pages for the UEs 101 based on the rules established. For example, when a bin by a manager at a global level is caused to include a new selection, the landing page at the regional and country layer is adapted to present this content as well. The content management platform 111 fetches the global rules 117, which indicate that changes to the collection at the global layer (global bin) ripple through and are visible to the regional and country bin. The content management platform 111 also enables the manager to apply the overriding filters (e.g., local rules or filters) on the global rules in order to tailor the global rules to the specific needs of each group of user equipments based on factors such as local restrictions, device configuration, user preferences, etc.

In one embodiment, the respective online store application 107 of each UE 101 receives the aggregated set of services and displays the services on the landing page of the UE 101 for the user to select from. The online store application 107 may also collect data on user behavior regarding the selection of services as well as context information. Collected data (e.g., milieu information) can be transferred to the content management platform 111 to be used for affecting subsequent presentment of collections associated with one or more bins. As will be discussed more fully later on, the online store application 107 may also render a user interface for enabling

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, and the content management platform 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

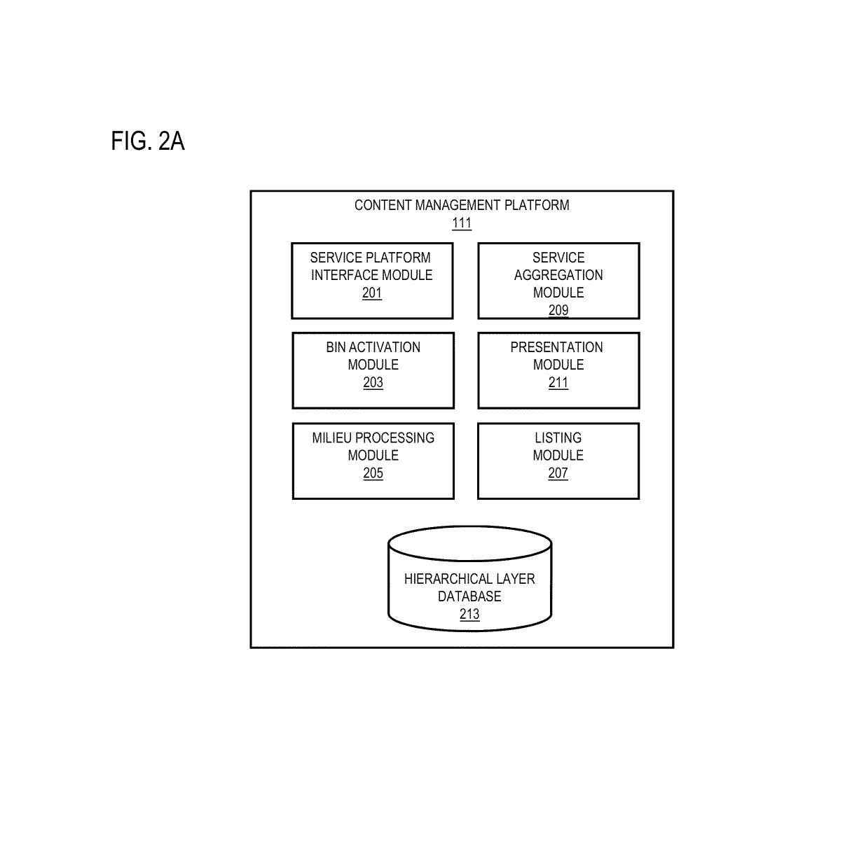

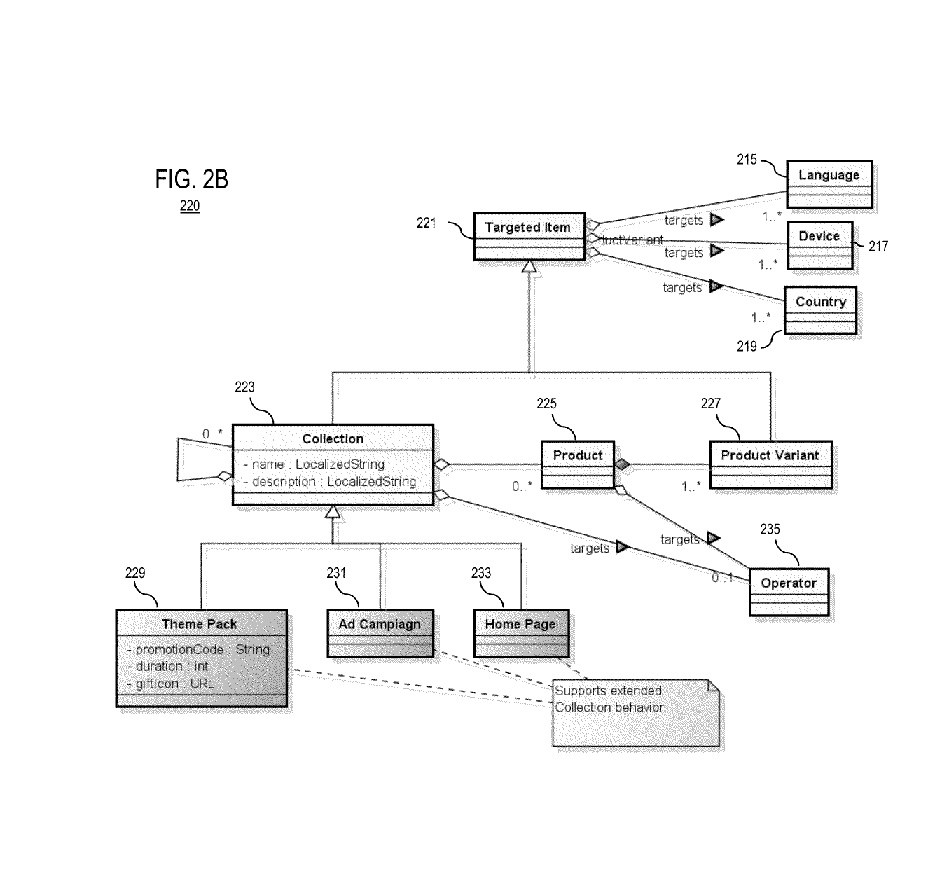

FIG. 2A is a diagram of the components of a content management platform, according to one embodiment. By way of example, the content management platform 111 includes one or more components for managing collections of content at various layers of a hierarchy. It is contemplated that the functions of these components may be combined in one or more components or performed by other components of equivalent functionality. In this embodiment, the content management platform 111 includes a service platform interface module 201, a bin activation module 203, a milieu processing module 205, a service aggregation module 209, a presentation module 211, a listing module 207, and a object model database 213. The content management platform 111 has connectivity with the service platform 103 and the user equipments 101 via the communication network 105.

In one embodiment, the service platform interface module 201 communicates with the service platform 103 to obtain global rules 117 which will be used as a basic set of rules for automatically determining the content to be presented to users of an online store (e.g., service platform 103) based, at least in part, on determining milieu information of the users and selecting the corresponding bin of the content collection. The global rules database 117 may include rules specific to each service 109 such as, service category (e.g., game, music, video, etc.), pricing, hardware and software requirements, licensing regulations, etc. The service platform interface module 201 may create a local copy of the rules database 117, access the database within the service platform 103, or a combination thereof.

The bin activation module 203, in certain embodiments, receives a request for establishing a bin configuration from the bin generator 115 of the service platform 103. In response to the request, the bin activation module accesses an object model database 213 for enabling the bin to be associated with a given hierarchical layer according to the rules base 117. The object model database 213 may include information for defining the underlying hierarchical layers of a given online service provider, the criteria for defining a collection, programmatic code for executing one or more collections and/or bins, object execution data, etc.

FIG. 2B is a diagram of a collection object model employed by the content management platform, according to one embodiment. As shown, the object model 220 includes a collection of objects and/or classes conforming to a specific object oriented programming language (e.g., Java). For example, a collection class 223 may be defined to include attributes ‘name’ and ‘description,’ corresponding to the name and description of an instance of a collection. Associated with the collection class 223, as linked, are classes product 225 and operator 235. These classes 225 and 227 correspond to an instance of a product and operator respectively. By way of example, multiple instances of products and/or operators may be linked to a single collection. In addition, a product variant class 227 may be further linked to the product class object 225 for enabling variations of products (e.g., color variation, feature variation) to be further associated with an instance of a collection.

A top level class 221, classified as targeted item, is linked to the collection class 223 or product variant class 227. By way of example, the targeted item class 221 may correspond to a bin of a collection. The targeted item class 221 is linked to a language class 215, device class 217 and country class 219, which correspond to specific targeted characteristics for defining a bin at a particular hierarchical layer of the collection. For example, the targeted classes 215-219 may include attributes for matching against milieu criteria of a given user and/or device attempting to activate a bin of the collection. Collections and/or bins are therefore targeted by country, device, language, and operator, such as to enable context based product boosting and hierarchical bin specification.

The collection class 223 is also linked to a theme pack class 229, advertisement campaign class 231 and home page class 233. The theme pack class 229 is further defined to include promotionCode, duration and gifticon attributes, corresponding to a specific promotional code value, theme or offer expiration date and icon for representing a specific promotion or theme. The advertisement campaign class 231 and home page class 233 support one or more instances of an advertisement campaign (e.g., marketing message) or website featuring online store content. It is noted that each of these classes 229-233 support extended content collection behavior.

In addition, the object model database 213 includes data for indicating the level of hierarchical access of a given content manager due to differing levels of access. The object model may be executed by the bin generator 115 for supporting activation of bins, e.g., adding selections, deleting selections, sorting content within a bin.

In one embodiment, the bin activation module 203 propagates the creation or adaption of one or more content selections of a bin to all the other bins at a lower level of the hierarchical structure according to the rules base 117. This includes the deleting, adding or re-sorting of content in various other bins of the hierarchy on the basis of the activated bin. The bin activation module 203 may also operate in connection with one or more filters (not shown) for affecting the ordering of various content selections in accordance with the established rules base 117. It is noted that the filters may be established to determine content programming to be stored (e.g. in the form of RDF graphs). The service platform administrators may then preview the rule or filter behavior, such as by observing how a content collection of the online store may be presented under different milieu scenarios, before approving the rules or filters to go live (public). It is noted that the propagation of content selections, sorting of content, previewing of content, and other executions are carried out according to the one or more classes defined by the object model 220 (FIG. 2B).

In one embodiment, a milieu processing module 205 is configured to process milieu information pertaining to one or more users or devices having access to the online store. Milieu information may include location information, user information, device information, preference information, buying history and habits information, and/or any other data for characterizing one or more users, devices, or a combination thereof. The module 205 processes the information to determine one or more bins of a collection that may match a request for access to content by a user. This ensures that one or more activated bins match the user criteria (e.g., interests, location, demographic) are presented to the user accordingly.

Following the activation of one or more bins via the bin activation module for affecting the display of content collection for a UE 101, the content manager may want to view the potential appearance of the content collection based on the new/modified bins. For this purpose, in one embodiment, the administrator may activate the service aggregation module 209 to provide a preview and enable the administrator to make any updates. Furthermore, the administrator may request to see various possible bins as they will appear to users in an easy and user friendly way for comparison and evaluation. In one embodiment, a preview panel provided by the service aggregation module 209 may allow the administrator to, for example, select the country and the type of UE 101 (or any other milieu information) and to see, by refreshing the preview, how the collection will appear for those selections. As a result, the administrator will be able to quickly check the content collection in key markets based on location or demographics, and apply further filter modifications if necessary. In one embodiment, the preview panels may be stored for later reference. It is noted that this corresponds to one or more executions of a bin configuration interface made available to the manager.

The service aggregation module 209 may then generate the content collection structure for one or more UEs 101, and activate the presentation module 211 to present the appropriate bins of the content collection to the UEs 101. The online store application 107 of the UE 101 receives the bins to display, and displays the page on the UE's display.

In one embodiment, the listing module 207 enables the content manager to create whitelists and blacklists within a given collection, so that content specified in the any bin of the collection can be promoted or removed in the corresponding bin. By way of example, a content manager may specify a whitelist of items that is to be promoted within a content collection. In this way, a promoted or advertised item may be given preference with rendering a display of the content. Similarly, a content manager may specify a blacklist of items that are not be presented when displaying a content collection. For example, local laws may prohibit certain types of content, cultural norms do not permit certain content, etc. It is contemplated, that a whitelist or blacklist may be specified for the entire hierarchy, for only certain hierarchical layers, or for individual hierarchical layers.

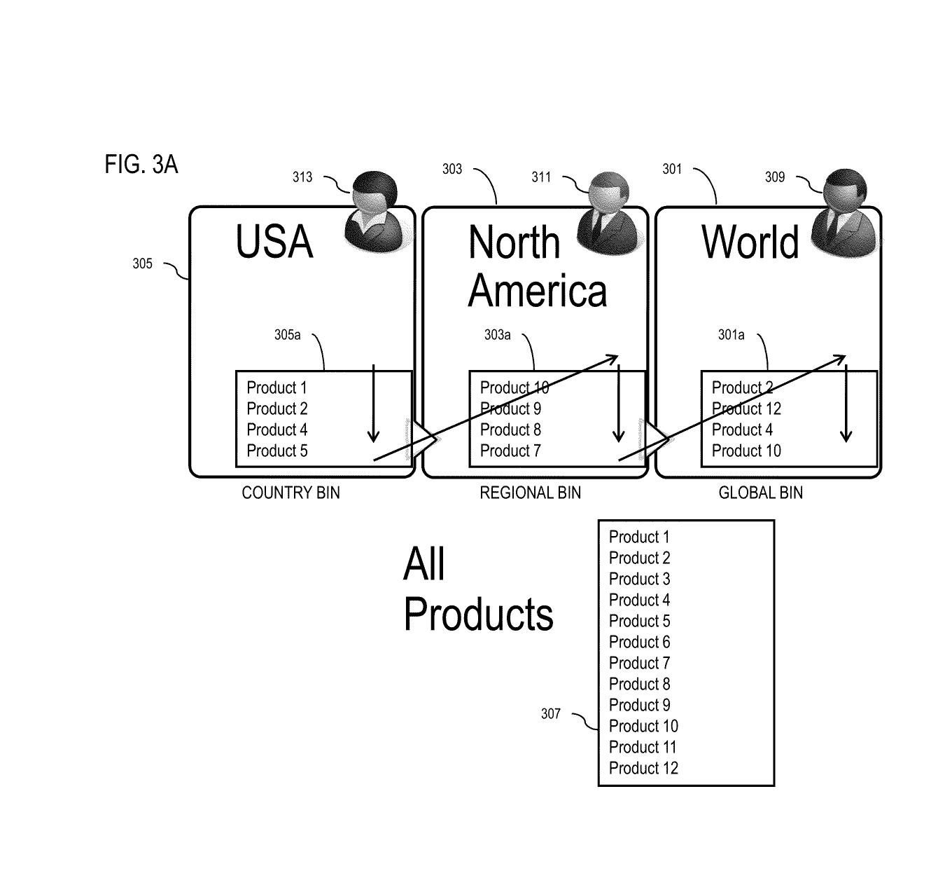

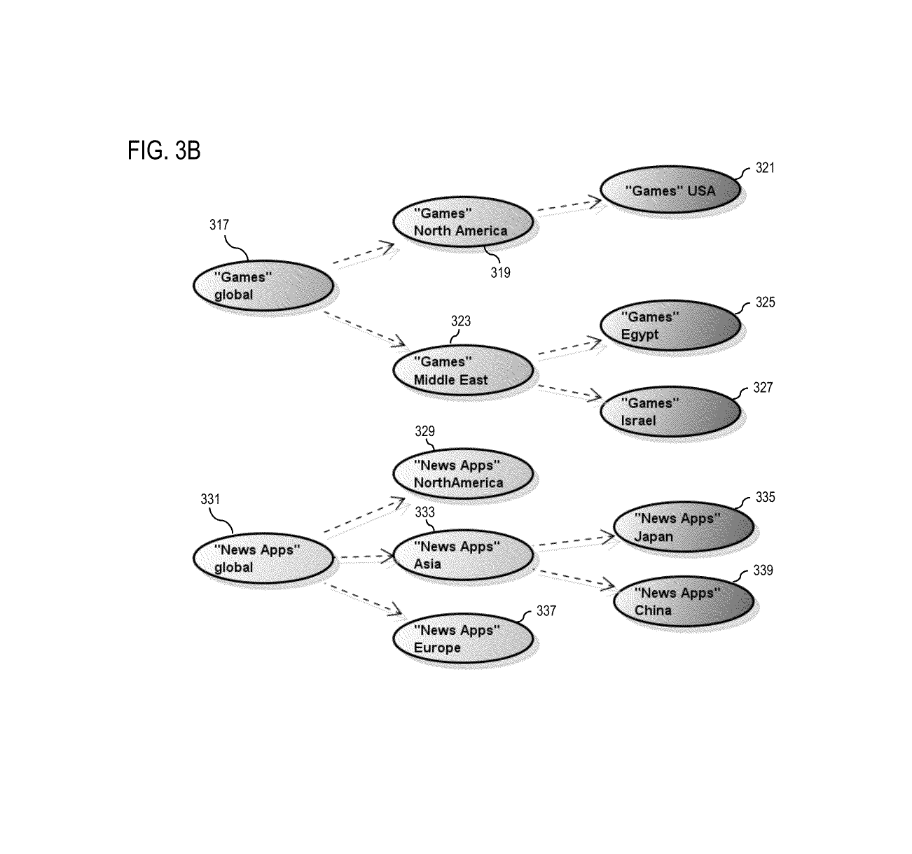

FIG. 3A is a diagram depicting reconciliation content to be displayed across multiple bins of a content collection, according to one embodiment. The diagram is presented from the perspective of the various executions of the content management platform 111 as well as the various processing rules 117 maintained by the service platform 103. In this example, the content collection of FIG. 3A includes three bins corresponding to three hierarchical layers that are to be displayed to a user (e.g., a user his milieu information indicate the user's location is the USA). In this case, a USA location meets the criteria for displaying content from a global bin 301 corresponding to the world, a regional bin 303 corresponding to North America, and a country bin 305 corresponding to the USA. As noted, the number of bins to be displayed or activated when meeting criteria of the milieu information is configurable. In certain embodiments, the number of bins can be extended to support further refinement, for example, by an administrator of the content store.

The bins 301-305 contains an ordered list of content 301a-305a respectively, which in this example, corresponds to content related to one or more products available for purchase/download/order at the online store for a given hierarchical layer. The content management platform 111 enables the content from a list of all products 307 to be selected for addition to a particular bin 301, while maintaining a preferred order of listing.

A global manager 309 adjusts or creates content in the global bin 301, while a regional manager 311 and country manager 313 adjust or create content in the regional and country bins 303 and 305 respectively. In this example, the content management platform 111 has been configured to combine and present the content items from all three bins 301-305 matching the user's milieu information. In one embodiment, to produce a combined display of multiple bins of the content collection, the content management platform 111 begins with the most specific bin (e.g., the country bin 305). By way of example, the country content list 305a includes products 1, 2, 4 and 5. Accordingly, the content management platform 111 displays these products first.

Next, the content management platform 111 proceeds to the next less specific layer (e.g., the regional bin 303), which includes a regional content list 303a listing products 10, 9, 8 and 7. Because list 303a contains no duplicates with list 305a, the content management platform 111 proceeds to initiate the display of the products of the list 303a immediately after the products of the list 305a in the order as listed. Next, the content management platform 111 proceeds to the highest layer (e.g., the global bin 301) which includes a list 301a of products 2, 12, 4, 10. In this case, the list 301a includes three duplicate entries from the previous two lists 303a and 305a (e.g., products 2, 4, and 10). Accordingly, the content management platform 111 displays the only non-duplicate product (e.g., product 12). This process then results in a final presentation order of products 1, 2, 4, 5, 10, 9, 8, 7, and 12.

FIG. 3B is a diagram of an override scenario for one or more bins at one or more hierarchical layers of a content collection, according to one embodiment. As noted previously, overriding pertains to the extent of permission or authorization granted a content manager at one hierarchical level for affecting the generation or modification of content and/or bins at other levels. This includes, for example, permissions for sorting content, defining bins, eliminating content, adding content, etc. By way of example, the exemplary use case scenario depicts an interaction between content managers operating at different hierarchical layers, including a global store manager, regional store manager and country store manager. Global store managers specify content at a global level, regional store managers can augment at a regional level and the country store manager can augment at the country level.

Under this scenario, the global store manager specifies content for inclusion in a bin 317 named “Games” at a global layer as part of a games content collection. The regional store manager for the Middle East region augments the content included in the collection 317 to generate a “Games” bin for the Middle East 323. By way of example, the regional store manager adds content popular in the region as well as removes content that may be perceived as offensive to customers in that region (e.g., based on cultural, religious and/or language differences). Another regional store manager for the North American region also generates a “Games” bin 319, augmented to include content of interest to that region.

A country store manager for the country Israel further refines the “Games” bin for Israel 327, while a manager in Egypt refines the preceding “Games” bin 323 to produce a bin 325 suitable for that region. This may include, for example, adding and removing content from the collection as suited for Israel and Egypt. A “Games” bin 321 for the United States of America is also generated as a modification of its regional counterpart 319.

According to the override rules of the various embodiments described herein, the bins at the more specific hierarchical will override the less specific layers above. For example, because bin 319 for North America and bin 323 for the Middle East have been specified, users from those region will see the more specific content items of bins 319 and 323 rather than the more general bin 317. For user from other regions, they will be presented with the list of game items from the global bin 317, because no more specific bin has been specified for them. As shown, a more specific bin 321 for the USA has been specified from the North American bin 319; and bin 325 for Egypt and bin 327 for Israel has been specified from the Middle Eastern bin 323. Accordingly, users from the USA, Egypt, and Israel will be presented with a more specific list of games from their respective bins.

As another example, a global store manager specifies content for inclusion in a bin 331 named “News Apps” at a global layer as part of a news apps content collection. The regional store managers for North America, Asia and Europe augment the news apps collection to generate respective bins 329, 333, and 337 appropriate for the respective regions they represent. For the Asian bin 333, country managers for Japan and China have also specified, respectively, more specific bins 335, and 339. As described in the process above users whose milieu information matches the location criteria for each bin will be presented with the list of news apps appropriate for their location.

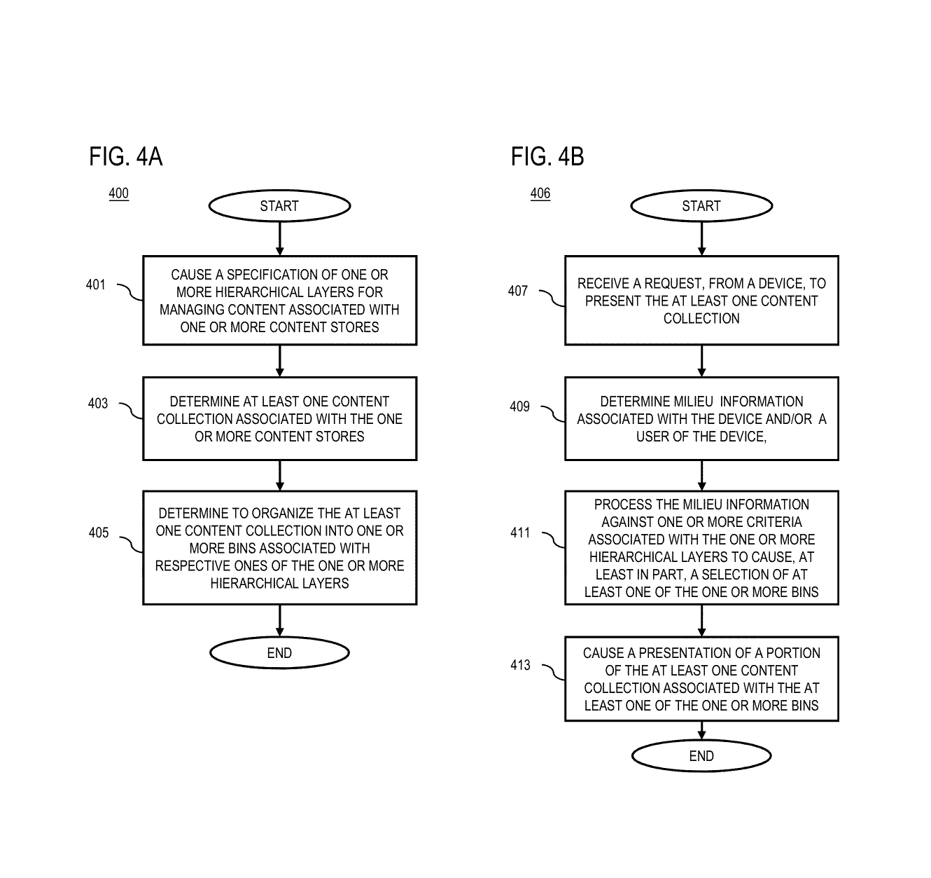

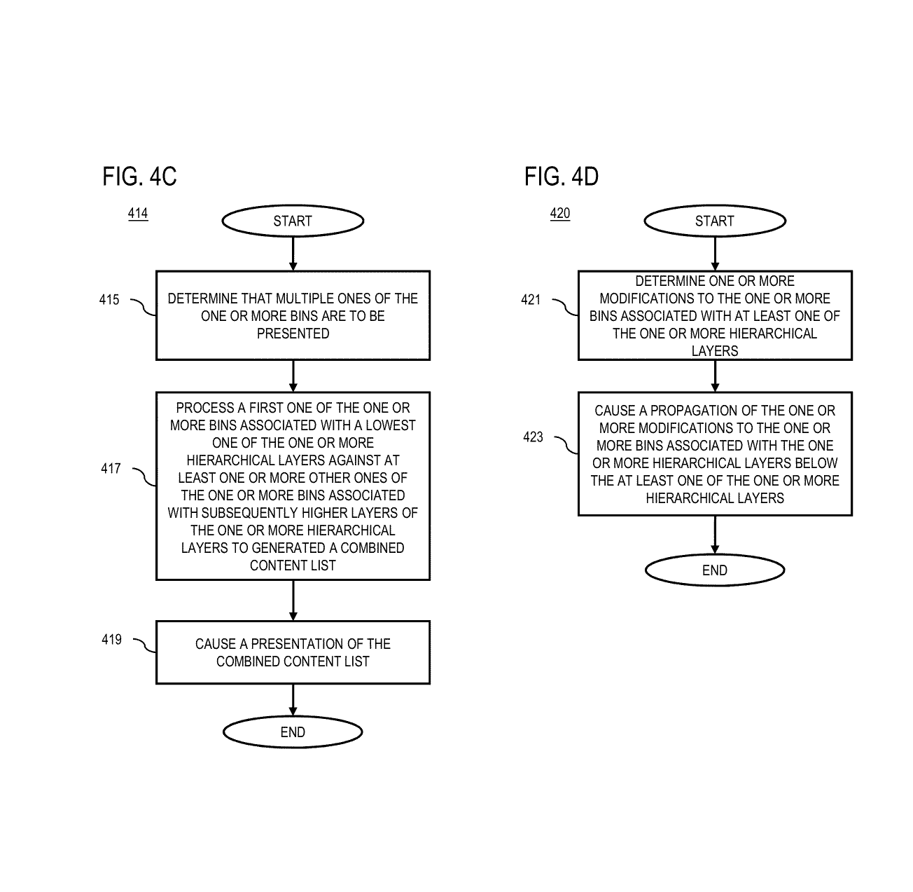

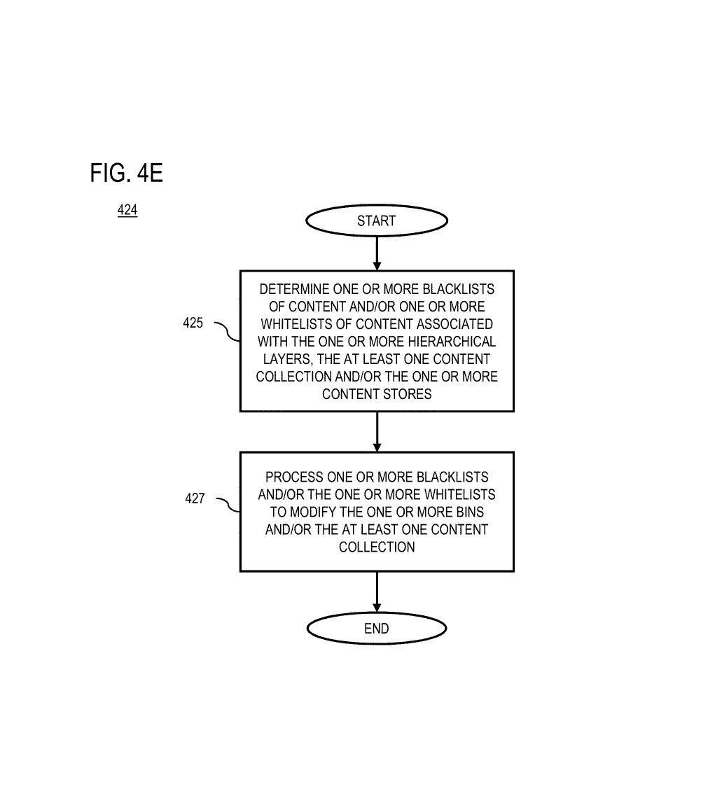

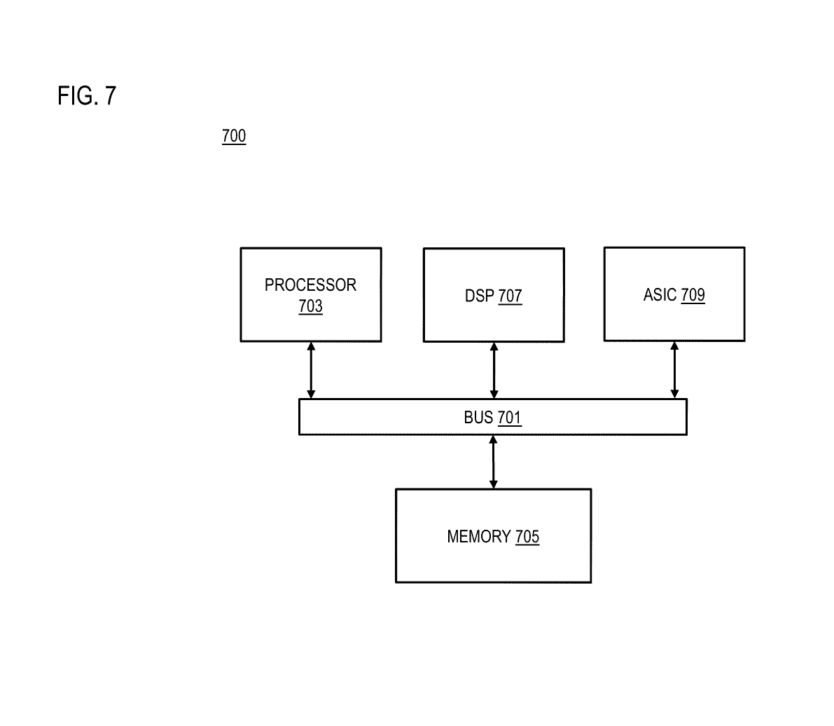

FIGS. 4A-4E are flowcharts of processes for managing content collections at various hierarchical layers, according to various embodiments. In one embodiment, the content management platform performs the process 300 and is implemented in, for instance, a chip set including a processor and a memory as shown in FIG. 7.

In step 401 of process 400 (FIG. 4A), the platform 111 causes a specification of one or more hierarchical layers for managing content associated with one or more content stores. By way of example, the hierarchical layers are defined by the service provider of the online store, and maintained in a hierarchical layer database of the content management platform 111. In one embodiment, the hierarchical layers may be based, at least in part, on location, demographics, etc. In step 403, a content collection associated with the one or more content stores is determined. In another step 405, the platform 111 determines to organize the at least one content collection into one or more bins associated with respective ones of the one or more hierarchical layers. As such, the bins are organized such that they correspond to a layer based on a location/geographic category, a demographic category, etc.

In step 407 of process 406 (FIG. 4B), the platform receives a request from a device to present the at least one content collection. As noted previously, the requesting device may be a user device, e.g., UE 101, of a given user accessing the online store. In step 409, the milieu information associated with the device is determined. The milieu information may include location information, device status information, user preferences data, activity information, time information, etc. Once received, per step 411, this information if processed against one or more criteria associated with the one or more hierarchical layers to cause a selection of at least one of the one or more bins. The criteria may include, for example, a country, region or global category of a particular bin type for matching against the specified location of the user of the requesting device.

Per step 413, the platform 111 causes a presentation of a portion of the at least one content collection associated with the at least one or more bins. It is noted that filtering on the basis of location criteria, for example, enables the calling of only the most relevant collections of content from the content database maintained by the service platform 103. Furthermore, only those collections relevant to the user are presented—e.g., based on the milieu information for the user.

Per step 415 of process 414 (FIG. 4C), the content management platform 111 determines that one of the one or more bins are to be presented, such as in association with a given set of milieu information pertaining to a given user. In response, per step 417, the content management platform 111 processes a first one of the one or more bins associated with a lowest one of the one or more hierarchical layers against at least one or more other ones of the one or more bins associated with subsequently higher layers of the one or more hierarchical layers to generate a combined content list. Hence, the processing is performed at successive layers of bins relative to the milieu information of the user and/or device for which bins are to be presented. In another step 419, the platform 111 causes a presentation of the combined content list pursuant to the processing. In one embodiment, the processing is performed to reconcile duplicates, sort orders, etc. associated with the multiple bins to be displayed.

In step 421 of process 420 (FIG. 4D), the content management platform determines one or more modifications to the one or more bins associated with at least one of the one or more hierarchical layers. Per step 423, the platform causes a propagation of the one or more modifications to the one or more bins associated with the one or more hierarchical layers below the at least one of the one or more hierarchical layers. As noted previously, propagation of the modifications at successively lower layers (e.g., from the global layer down) ensures consistency and concurrency of content collections amongst different content managers. This propagation is based, at least in part, on an override execution corresponding to the structure of the hierarchy. In other words, the propagation downward through the hierarchy can act as a suggestion to the respective managers who still retain to ability to override any selection or suggestion from a manager at a higher level.

In step 425 of process 424 (FIG. 4E), the platform 111 determines one or more blacklists of content, one or more whitelists of content, or a combination thereof associated with the one or more hierarchical layers, the at least one content collection, the one or more content stores, or a combination thereof. The lists are established by the content manager for supporting the restriction or inclusion of specific content selections for the respective hierarchical layers. Per step 427, the platform processes the one or more blacklists, the one or more whitelists, or a combination thereof to modify the one or more bins, the at least one content collection, or a combination thereof. Hence, the selections specified on the blacklists and/or whitelists may affect what content or collections thereof are presented/maintained in various bins. It is noted that the one or more blacklists or whitelists apply to a subset of the one or more hierarchical layers or an entirety of the one or more hierarchical layers. As previously discussed, whitelists are for promoting content items and blacklists are for banning content items.

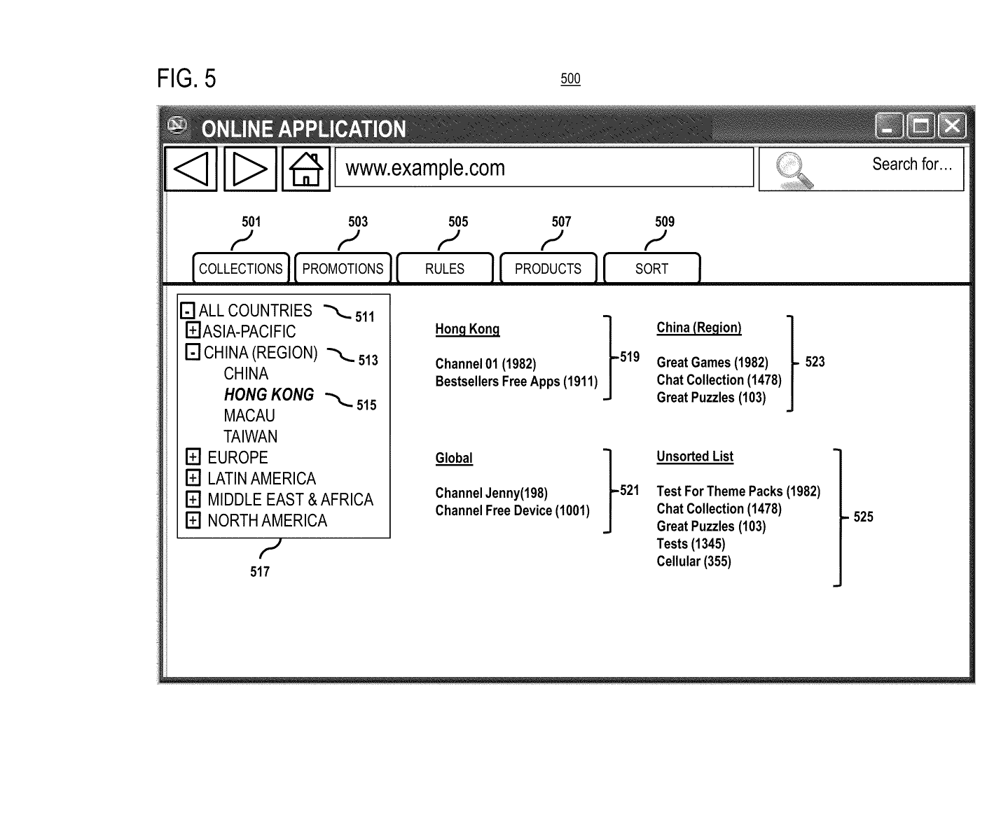

FIG. 5 is a diagram of a user interface for configuring one or more collections, according to one embodiment. The diagram corresponds to a configuration management interface, which may be accessed from example, by way of the online store application 107 of FIG. 1 via a manager login process.

The configuration management interface 500 includes various tabs 501-509 for enabling a manager to configure the content in one or more bins of one or more collections. A first tab corresponds to a Collections tab 501, which upon selection activates a listing of the various defined bins and their hierarchical layers. The Promotions tab 503 presents a listing of the various online store/merchant promotions or whitelists to which the one or more collections and/or the one or more bins are affiliated. For example, a collection of video games may be associated with a specific half off sale at an online video game application store. This sale may apply globally or to only specific regions, countries, etc.

The Rules tab 505 enables the content manager, if their permissions allow, to adapt one or more override and/or propagation behaviors of the content management platform 111 in the configuration of a bin. For example, a manager at a global layer of the hierarchy may define a whitelist that prevents certain company preferred content from being deleted at the regional and country levels despite attempted changed. In certain embodiments, the listing of rules may be overridden depending on the determined level of clearance and/or permission of a given content manager, e.g., global overrides one or more regional manager rules.

The Products tab 507 presents a list of all the products available for selection with respect to one or more bins and/or one or more collections, while the Sort tab 509 enables the content manager to adapt the sorting of content within a bin or collection.

In this instance, the order of the bins within a collection is being managed via the configuration interface 500. The interface 500 features various links for enabling the ordering of bins at a global, regional and country level, as supported by various links 517. The All Countries link 511 corresponds to a global bin that is the highest layer of the hierarchy. Upon selection of this link 511, a hierarchical list of sub-links available for selection is presented. These sub-links correspond to one or more regional bins corresponding to a regional layer, a secondary layer of the hierarchy. When the user selects a CHINA link 513, more links are presented corresponding to one or more country bins; a tertiary layer of the hierarchy.

Selection of a particular link causes presentment of the specific content items associated with each bin. For example, an unsorted collection of content 525 is presented, which features all of the various content selections in no particular order. Upon selection of the All Countries link, the Global bin 521 is presented to feature various content items. Under this scenario, the listing for the content items in a bin include a name of the content (e.g., Channel Jenny and Channel Free Device), followed by a number indicating the number of products associated with that content item.

Upon selection of the China link 513, the various content items for that China bin 523 are shown. Likewise, selection of the Hong Kong link 515 results in presentment of the content items for the Hong Kong bin 519.

The processes described herein for managing collections of content at various layers of a hierarchy may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

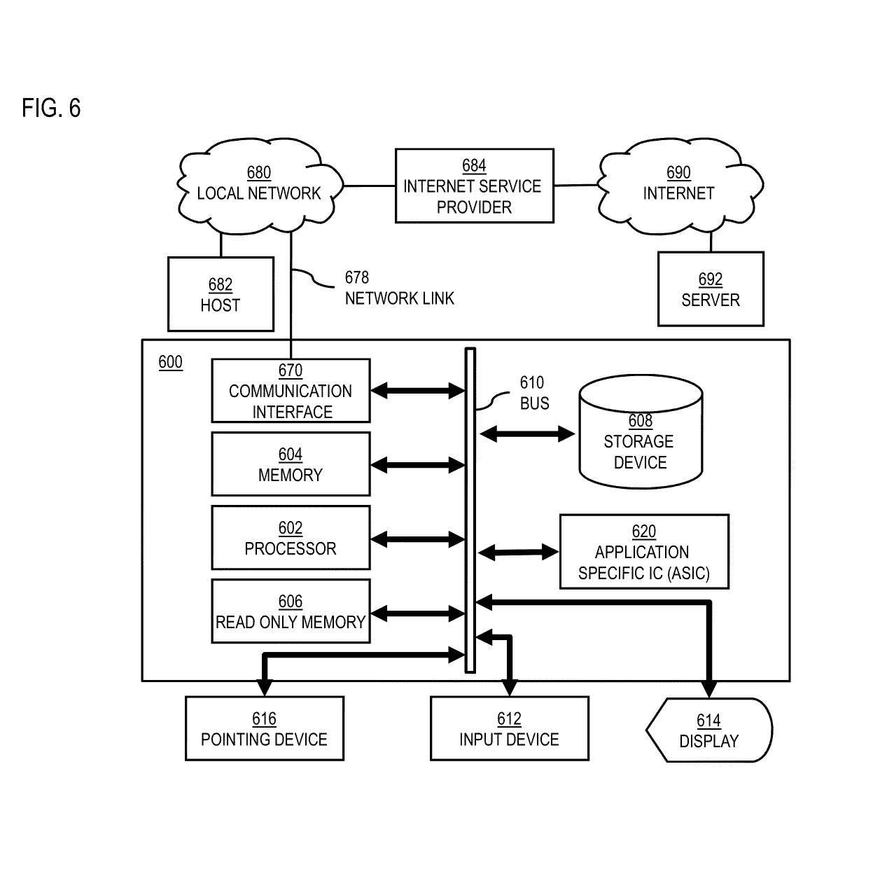

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to manage collections of content at various layers of a hierarchy as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of managing collections of content at various layers of a hierarchy.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to manage collections of content at various layers of a hierarchy. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for managing collections of content at various layers of a hierarchy. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for managing collections of content at various layers of a hierarchy, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for managing collections of content at various layers of a hierarchy to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to manage collections of content at various layers of a hierarchy as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of managing collections of content at various layers of a hierarchy.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to manage collections of content at various layers of a hierarchy. The memory 705 also stores the data associated with or generated by the execution of the inventive steps.

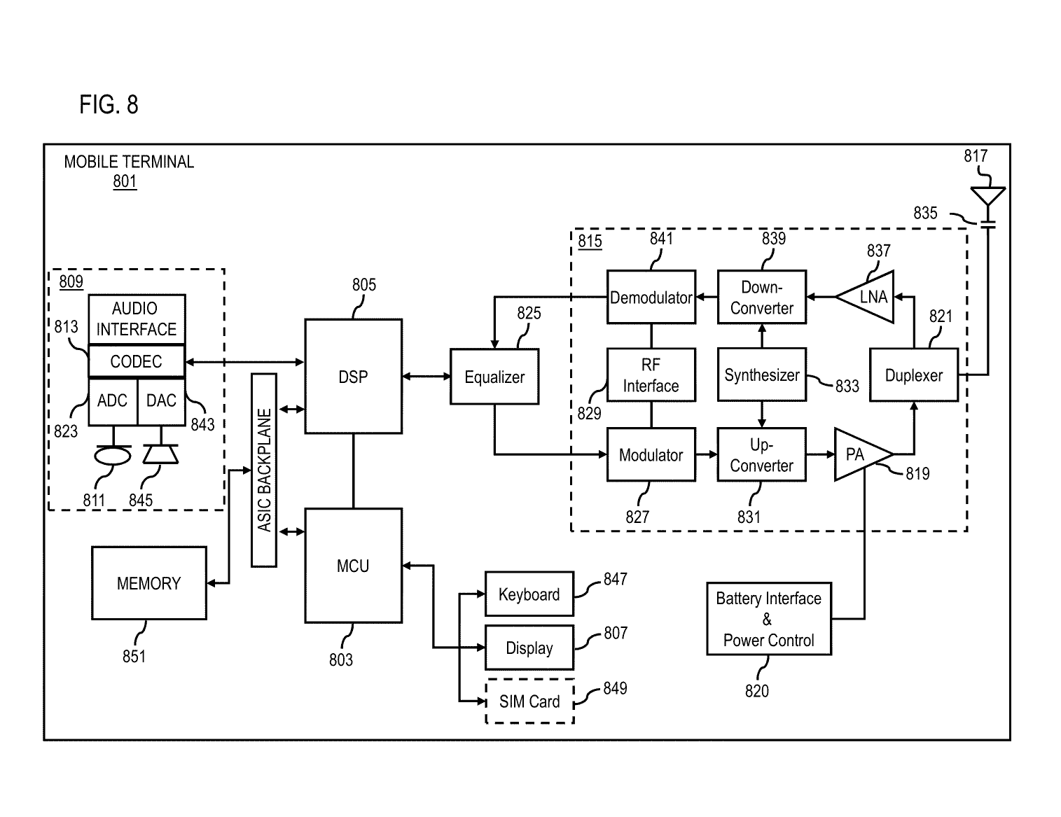

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of managing collections of content at various layers of a hierarchy. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of managing collections of content at various layers of a hierarchy. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to manage collections of content at various layers of a hierarchy. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a specification of one or more hierarchical layers for managing content associated with one or more content stores;
at least one content collection associated with the one or more content stores; and
at least one determination to organize the at least one content collection into one or more bins associated with respective ones of the one or more hierarchical layers.

2. A method of claim 1, wherein the (1) data and/or (2) information and/or (3) at least one signal are further based, at least in part, on the following:
a request, from a device, to present the at least one content collection;
milieu information associated with the device, a user of the device, or a combination thereof;
a processing of the milieu information against one or more criteria associated with the one or more hierarchical layers to cause, at least in part, a selection of at least one of the one or more bins; and
a presentation of a portion of the at least one content collection associated with the at least one of the one or more bins.

3. A method of claim 1, wherein the (1) data and/or (2) information and/or (3) at least one signal are further based, at least in part, on the following:
at least one determination that multiple ones of the one or more bins are to be presented;
a processing of a first one of the one or more bins associated with a lowest one of the one or more hierarchical layers against at least one or more other ones of the one or more bins associated with subsequently higher layers of the one or more hierarchical layers to generated a combined content list; and
a presentation of the combined content list.

4. A method of claim 1, wherein the (1) data and/or (2) information and/or (3) at least one signal are further based, at least in part, on the following:
one or more modifications to the one or more bins associated with at least one of the one or more hierarchical layers; and
a propagation of the one or more modifications to the one or more bins associated with the one or more hierarchical layers below the at least one of the one or more hierarchical layers.

5. A method of claim 4, wherein the one or more modifications do not propagate to the one or more hierarchical layers higher than the at least one of the one or more hierarchical layers.

6. A method of claim 1, wherein the one or more hierarchical layers are based, at least in part, on a location-based hierarchy, a demographic-based hierarchy, or a combination thereof.

7. A method of claim 1, wherein the (1) data and/or (2) information and/or (3) at least one signal are further based, at least in part, on the following:
one or more blacklists of content, one or more whitelists of content, or a combination thereof associated with the one or more hierarchical layers, the at least one content collection, the one or more content stores, or a combination thereof; and
a processing of the one or more blacklists, the one or more whitelists, or a combination thereof to modify the one or more bins, the at least one content collection, or a combination thereof.

8. A method of claim 7, wherein the one or more blacklists, the one or more whitelists, or a combination thereof apply to a subset of the one or more hierarchical layers or an entirety of the one or more hierarchical layers.

9. A method of claim 1, wherein the one or more bins specify respective one or more content items, respective content sort orders, or a combination thereof.

10. An apparatus comprising:
at least one processor; and
at least one memory including computer program code for one or more programs,
the at least one memory and the computer program code configured to, with the at least one processor, cause the apparatus to perform at least the following,
cause, at least in part, a specification of one or more hierarchical layers for managing content associated with one or more content stores;
determine at least one content collection associated with the one or more content stores; and
determine to organize the at least one content collection into one or more bins associated with respective ones of the one or more hierarchical layers.

11. An apparatus of claim 10, wherein the apparatus is further caused to:
receive a request, from a device, to present the at least one content collection;
determine milieu information associated with the device, a user of the device, or a combination thereof;
process and/or facilitate a processing of the milieu information against one or more criteria associated with the one or more hierarchical layers to cause, at least in part, a selection of at least one of the one or more bins; and
cause, at least in part, a presentation of a portion of the at least one content collection associated with the at least one of the one or more bins.

12. An apparatus of claim 10, wherein the apparatus is further caused to:
determine that multiple ones of the one or more bins are to be presented;
process and/or facilitate a processing of a first one of the one or more bins associated with a lowest one of the one or more hierarchical layers against at least one or more other ones of the one or more bins associated with subsequently higher layers of the one or more hierarchical layers to generated a combined content list; and
cause, at least in part, a presentation of the combined content list.

13. An apparatus of claim 10, wherein the apparatus is further caused to:
determine one or more modifications to the one or more bins associated with at least one of the one or more hierarchical layers; and
cause, at least in part, a propagation of the one or more modifications to the one or more bins associated with the one or more hierarchical layers below the at least one of the one or more hierarchical layers.

14. An apparatus of claim 13, wherein the one or more modifications do not propagate to the one or more hierarchical layers higher than the at least one of the one or more hierarchical layers.

15. An apparatus of claim 10, wherein the one or more hierarchical layers are based, at least in part, on a location-based hierarchy, a demographic-based hierarchy, or a combination thereof.

16. An apparatus of claim 10, wherein the apparatus is further caused to:
determine one or more blacklists of content, one or more whitelists of content, or a combination thereof associated with the one or more hierarchical layers, the at least one content collection, the one or more content stores, or a combination thereof; and
process and/or facilitate a processing of the one or more blacklists, the one or more whitelists, or a combination thereof to modify the one or more bins, the at least one content collection, or a combination thereof.

17. An apparatus of claim 16, wherein the one or more blacklists, the one or more whitelists, or a combination thereof apply to a subset of the one or more hierarchical layers or an entirety of the one or more hierarchical layers.

18. An apparatus of claim 10, wherein the one or more bins specify respective one or more content items, respective content sort orders, or a combination thereof.

19. A computer-readable storage medium carrying one or more sequences of one or more instructions which, when executed by one or more processors, cause an apparatus to perform:
causing, at least in part, a specification of one or more hierarchical layers for managing content associated with one or more content stores;
determining at least one content collection associated with the one or more content stores; and
determining to organize the at least one content collection into one or more bins associated with respective ones of the one or more hierarchical layers.

20. A computer-readable storage medium of claim 19, wherein the apparatus is further caused to perform:
receiving a request, from a device, to present the at least one content collection;
determining milieu information associated with the device, a user of the device, or a combination thereof;
processing and/or facilitating a processing of the milieu information against one or more criteria associated with the one or more hierarchical layers to cause, at least in part, a selection of at least one of the one or more bins; and
causing, at least in part, a presentation of a portion of the at least one content collection associated with the at least one of the one or more bins.

21.-46. (canceled)
